(19) United States
(12) Patent Application Publication
(10) Pub. No.: US 2026/0088535 A1
(43) Pub. Date: Mar. 26, 2026

(54) BOARD CONNECTOR DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Akira MIYAJO, Yokkaichi-shi, Mie (JP); Makoto MASHITA, Yokkaichi-shi, Mie (JP); Takeshi HAGIHARA, Yokkaichi-shi, Mie (JP); Hirofumi URAYAMA, Yokkaichi-shi, Mie (JP); Masakatsu MORIGUCHI, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/710,039

(22) PCT Filed: Oct. 27, 2022
(86) PCT No.: PCT/JP2022/040160

§ 371 Date: May 14, 2024

(30) Foreign Application Priority Data
Nov. 17, 2021 (JP) 2021-187024

(51) Int. Cl. H01R 12/72

(52) U.S. Cl. CPC H01R 12/722

(57) ABSTRACT

A board connector device includes a main board, a main connector mounted on a mounting surface of the main board, a sub-connector including a second sub-board and attached to the main board in a state where the second sub-board is connected to the main connector, and a retainer provided in the sub-connector, holding the sub-connector in a state of attachment to the main board by latching onto the main board, and configured to disengage the sub-connector from the main board by detaching from the main board.

### CROSS-REFERENCE TO RELATED APPLICATIONS

This application is the U.S. national stage of PCT/JP2022/040160 filed on Oct. 27, 2022, which claims priority of Japanese Patent Application No. JP 2021-187024 filed on Nov. 17, 2021, the contents of which are incorporated herein.

### TECHNICAL FIELD

The present disclosure relates to a board connector device.

### BACKGROUND

JP 6801936 discloses a board connector device including a board and a connector into which the board is inserted. Terminal fittings each having an elastic contact piece are mounted to the connector. The terminal fittings each have an elastic contact piece that elastically contacts the board.

The above board connector device is capable of holding the terminal fittings and the board in a connected state by frictional resistance that arises from the elastic force of the elastic contact pieces. There is a concern that, in the case where this board connector device is installed in a vehicle, relative displacement of the board and the terminal fittings due to vibration during travel will lead to contact failure, and thus it is necessary to enhance the elastic force of the elastic contact pieces and increase the frictional resistance between the terminal fittings and the board. However, a downside of this is that resistance when inserting and removing the board with respect to the connector becomes excessive, and usability decreases. In particular, when disengaging the board from the connector, the board needs to be pulled forward, and thus it is difficult to disengage the board if there is nothing on the board to hook a finger onto.

A board connector device of the present disclosure has been completed based on circumstances such as the above, and an object thereof is to achieve an improvement in usability when disengaging a board.

### SUMMARY

A board connector device of the present disclosure includes: a main board; a main connector mounted on a mounting surface of the main board; a sub-connector including a sub-board and attached to the main board in a state where the sub-board is connected to the main connector; and a retainer provided in the sub-connector, holding the sub-connector in a state of attachment to the main board by latching onto the main board, and configured to disengage the sub-connector from the main board by detaching from the main board.

### Advantageous Effects

According to the present disclosure, an improvement in usability when disengaging a board can be achieved.

### BRIEF DESCRIPTION OF DRAWINGS

FIG. 1 is a perspective view of a board connector device, looking obliquely downward from the front.

FIG. 2 is a perspective view of a state where a sub-connector and a holding member are removed from the main board, looking obliquely downward from the front.

FIG. 3 is a perspective view of the sub-connector in an exploded state, looking obliquely downward from the front.

FIG. 4 is a perspective view of the sub-connector, looking obliquely downward from the rear.

FIG. 5 is a perspective view of the sub-connector in an exploded state, looking obliquely downward from the rear.

FIG. 6 is a perspective view of the sub-connector and the holding member, looking obliquely upward from the front.

FIG. 7 is a perspective view of a front member and a retainer in a separated state, looking obliquely upward from the front.

FIG. 8 is a cross-sectional side view showing a state where the sub-connector is attached to the main board.

FIG. 9 is a cross-sectional side view showing a state where latching by the retainer is released and the sub-connector is disengageable from the main board.

FIG. 10 is a bottom view showing a state where the sub-connector is attached to the main board.

FIG. 11 is a bottom view showing a state where latching by the retainer is released and the sub-connector is disengageable from the main board.

### DETAILED DESCRIPTION OF PREFERRED EMBODIMENTS

Initially, embodiments of the present disclosure will be enumerated and described.

In a first aspect, a board connector device of the present disclosure includes a main board, a main connector mounted on a mounting surface of the main board, a sub-connector including a sub-board and attached to the main board in a state where the sub-board is connected to the main connector, and a retainer provided in the sub-connector, holding the sub-connector in a state of attachment to the main board by latching onto the main board, and configured to disengage the sub-connector from the main board by detaching from the main board. According to the configuration of the present disclosure, the sub-board and the main connector are held in a connected state by the retainer, even if frictional resistance between the sub-board and the main connector is not enhanced, and thus an improvement in usability when disengaging the sub-board from the main connector can be achieved.

In a second aspect, preferably the retainer in the first aspect includes an operation part exposed on an outer periphery of the main board, in a state where the retainer is latched onto the main board, and the retainer is detached from the main board, by a pushing force parallel to the main board being applied to the operation part. According to this configuration, operability at the time of removing the sub-connector from the main board is good.

In a third aspect, preferably the retainer in the first or the second aspect has a projecting part disposed on a surface of the sub-connector opposing the mounting surface, and the projecting part is housed in a notch part formed in the main board, in a state where the sub-connector is attached to the main board. According to this configuration, the projecting part of the retainer is housed within the range of the thickness of the main board, and thus a reduction in profile in the plate thickness direction of the main board can be achieved, compared to the case where the projecting part is placed on the mounting surface of the main board.

In a fourth aspect, preferably the notch part of the third aspect is disposed only within a range of a region of the mounting surface covered by the sub-connector. According to this configuration, the mounting surface of the main board can be effectively utilized for disposition of circuits, elements, and the like.

In a fifth aspect, preferably the main board of the first through the fourth aspects is provided with a disengagement pushing part that pushes the sub-connector in a direction of disengagement from the main board. According to this configuration, when detaching the retainer from the main board, the sub-connector is pushed in the direction of disengagement from the main board by a disengagement pushing part, and thus usability at the time of disengagement is excellent.

In a sixth aspect, preferably the disengagement pushing part of the fifth aspect is made of an elastic material, and elastically pushes the sub-connector in the disengagement direction, in a state where the retainer is latched onto the main board. According to this configuration, usability when disengaging the sub-connector from the main board is further improved.

In a seventh aspect, preferably the main board of the sixth aspect is provided with a holding member that holds the sub-connector in a state of attachment to the main board by a frictional force between the holding member and the sub-connector, and an elastic force applied to the sub-connector by the disengagement pushing part is set to a strength exceeding a holding force applied by the holding member. According to this configuration, the sub-connector can be held in a state of attachment to the main board without any play. Also, the sub-connector can be disengaged from the main board and the holding member by the disengagement pushing part.

In an eighth aspect, preferably the holding member of the seventh aspect is made of a conductive material and has a box shape enclosing the sub-connector, and an outer conductor constituting the sub-connector contacts the holding member. According to this configuration, a high shielding effect can be obtained by the outer conductor and the holding member.

### EMBODIMENT 1

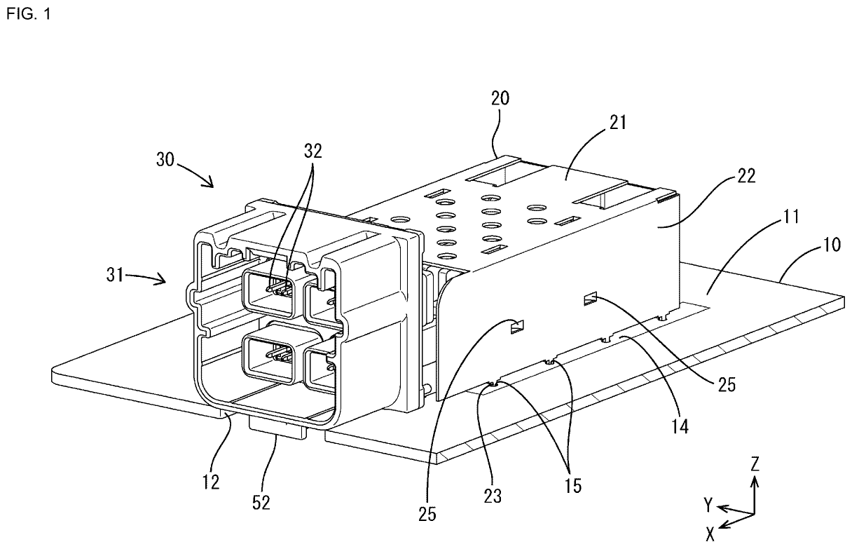

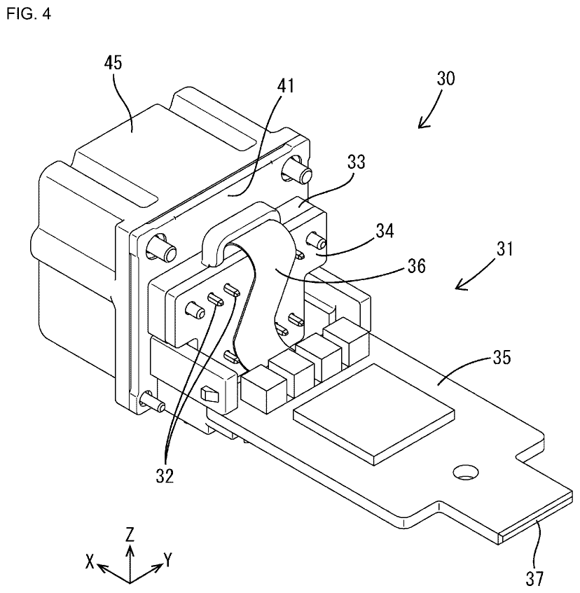

Embodiment 1 embodying the present disclosure will be described with reference to FIGS. 1 to 11. Note that the present disclosure is not limited to these illustrative examples and is indicated by the claims, and all changes that come within the meaning and range of equivalency of the claims are intended to be embraced therein. In Embodiment 1, with regard to the front and rear directions, the positive direction on the X axis in FIGS. 1 to 11 is defined as forward. With regard to the left and right directions, the positive direction on the Y axis in FIGS. 1 to 7, 10, and 11 is defined as right. With regard to the up and down directions, the positive direction on the Z axis in FIGS. 1 to 9 is defined as upward.

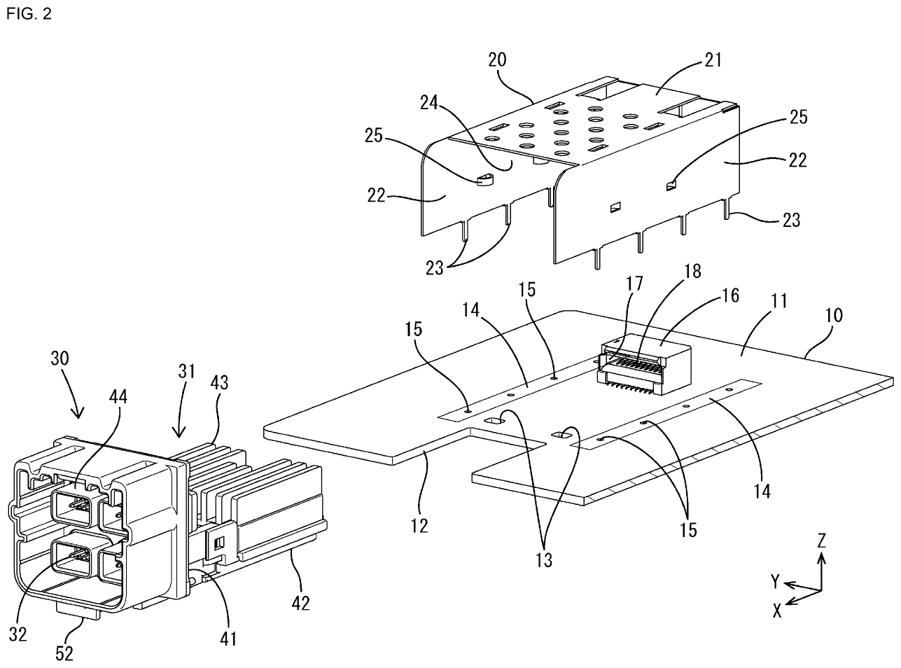

A board connector device of the present disclosure is, for example, installed in an automobile and constitutes an in-vehicle communication circuit for automatic driving control using Ethernet (registered trademark). As shown in FIGS. 1 and 2, the board connector device includes a main board 10, a main connector 16, and a sub-connector 30. The main connector 16 and the sub-connector 30 constitute a card edge connector. In Embodiment 1, for convenience, the main board 10 is assumed to be installed in the vehicle in a horizontally-oriented posture. The upper surface of the main board 10 functions as a mounting surface 11. Components such as a communication circuit (not shown) and a power supply circuit (not shown) consisting of an SoC (System on a chip), SiP (System in a package), and the like are attached to the mounting surface 11.

The main connector 16 is fixed to the mounting surface 11 of the main board 10. As shown in FIG. 2, the main connector 16 has a board housing space 17. The board housing space 17 is open in the shape of an elongated slit in the left right direction in the front surface of the main connector 16. The main connector 16 houses a plurality of terminal fittings 18 that face the inside of the board housing space 17.

As shown in FIG. 2, a notch part 12 is formed at a position on the main board 10 forward of the main connector 16. The notch part 12 has a rectangular shape in plan view looking at the main board 10 from above, and is open at the front end edge of the main board 10. A pair of latching holes 13 spaced apart in the left-right direction are formed on the main board 10. The pair of latching holes 13 are disposed at a position in a vicinity of the rear of the notch part 12 and are located forward of the main connector 16.

As shown in FIG. 2, a ground circuit 14 is formed on the mounting surface 11. A plurality of connection holes 15 having a shape that passes through the ground circuit 14 are formed in the main board 10. The plurality of connection holes 15 are spaced apart from each other in the front-rear direction in a region spanning from the latching holes 13 to the rear end portion of the main connector 16, and are disposed in two rows on the left and right. The two rows of connection holes 15 on the left and right are disposed so as to sandwich the latching holes 13 and the main connector 16 from both left and right sides.

A holding member 20 is attached to the main board 10. As shown in FIG. 2, the holding member 20 is a single member forming a rectangular box shape in which the front and lower surfaces are open, and includes an upper plate part 21 and two side plate parts 22 on the left and right. The holding member 20 is made of a conductive material such as a metal or a conductive resin, and has a shielding function. The holding member 20 is attached to the main board 10 by inserting leg parts 23 that protrude from the lower end edge of the left and right side plate parts 22 into the connection holes 15 and soldering (not shown) the inserted portions. A connection space 24 surrounded by the main board 10 and the holding member 20 is constituted upward of the main board 10. The connection space 24 is open forward. The main connector 16 is housed in a region of the rear end portion of the connection space 24.

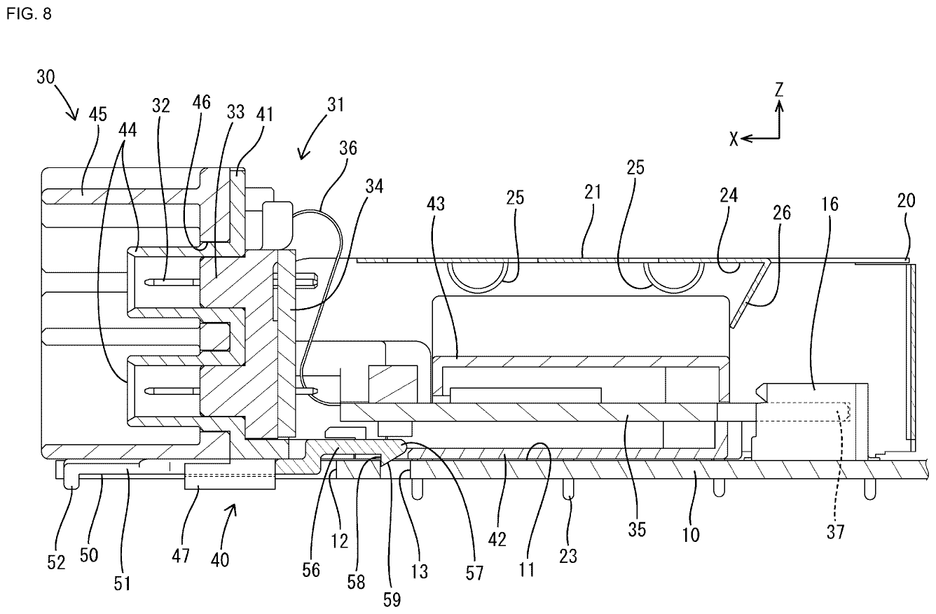

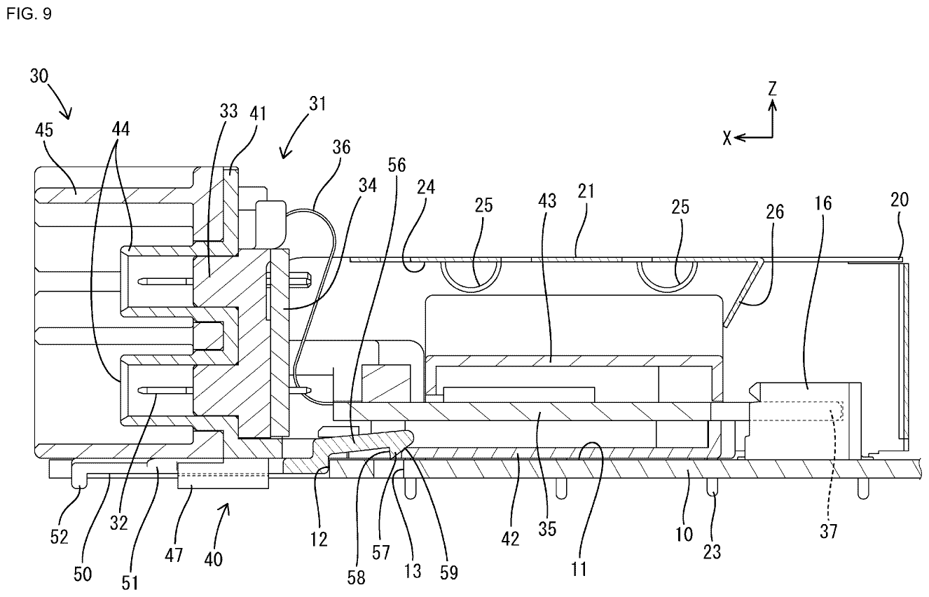

As shown in FIGS. 2 and 8, a plurality of holding protrusions 25 are formed on the upper plate part 21 and the left and right side plate parts 22. The holding protrusions 25 are formed so as to protrude inside the holding member 20 through a cutting and raising process. As shown in FIGS. 8 and 9, a pair of disengagement pushing parts 26 spaced apart in the left right direction are integrally formed on the holding member 20. The disengagement pushing parts 26 each have a shape in which part of the upper plate part 21 is cut and raised so as to protrude inside the holding member 20. The disengagement pushing parts 26 protrude obliquely downward toward the front in a plate shape from the upper plate part 21. The disengagement pushing parts 26 can elastically deform in the front-rear direction with the upper end edge connected to the upper plate part 21 as the point of support.

The sub-connector 30 is a connector having a shielding function, and has one card edge connection part 37 and a plurality of connection ports 44 as will be described later. In the present embodiment, a plurality of types of sub-connectors 30 having different numbers of connection ports 44 are provided with respect to the main board 10, which is a common member. In Embodiment 1, only one type of sub-connector 30 having four connection ports 44 is illustrated for convenience. One board connector device is constituted by attaching one sub-connector 30 suitably selected from the plurality of sub-connectors 30 to the main board 10 which is a common member.

An ECU (Electronic Control Unit) of a device for automatic driving control (not shown) attached to the vehicle body is connected to each connection port 44 of the sub-connector 30. An example of a device for automatic driving control is a LiDAR (Light Detection and Ranging). Given that the number of devices for automatic driving control differs depending on the grade of vehicle and the number of options, the number of connection ports 44 of the sub-connector 30 has to be changed according to the number of devices to be connected. The sub-connector 30 can be attached to and detached from the main connector 16 as necessary, and an increase or decrease in the number of connection ports 44 can be addressed without replacing the main board 10 having a common structure.

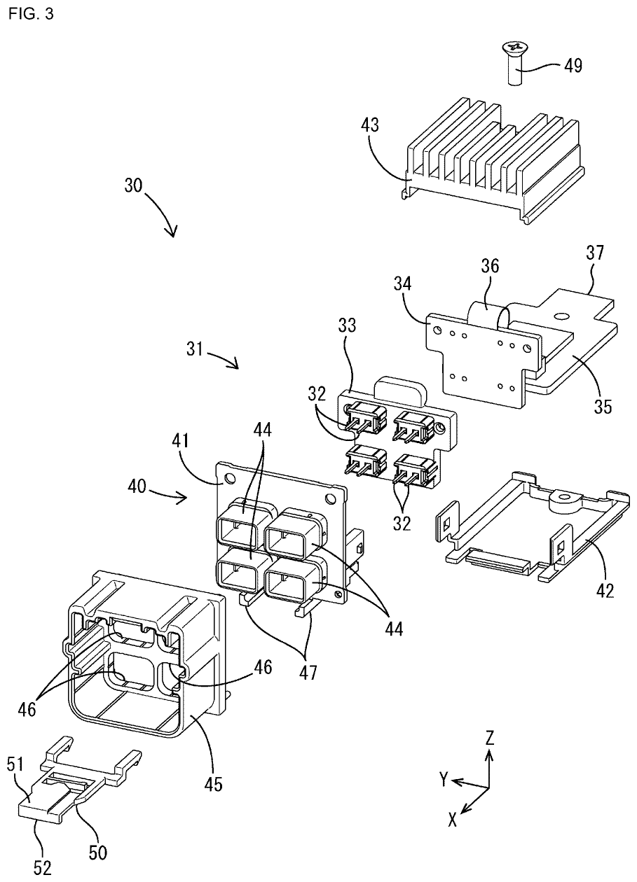

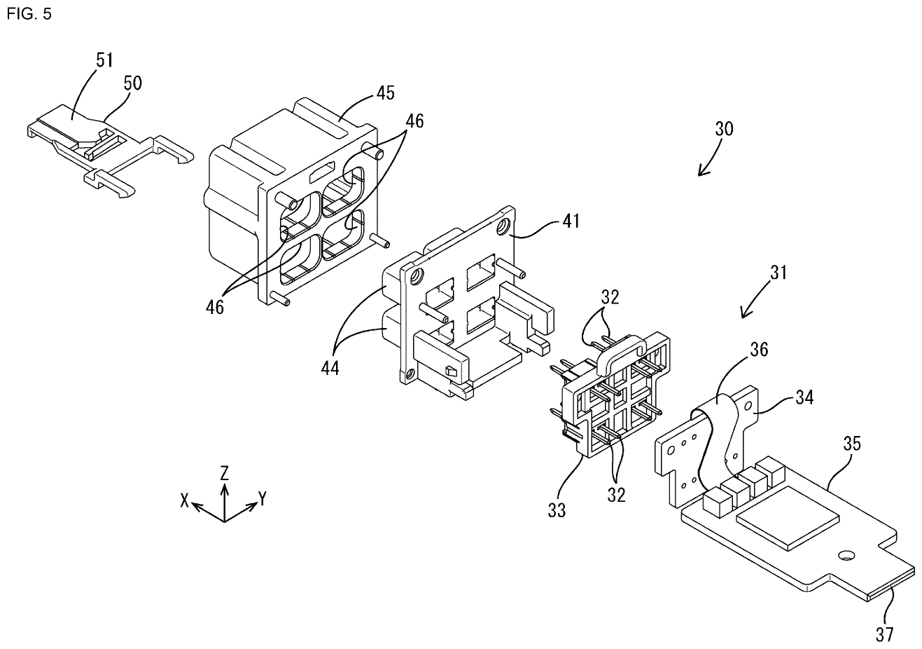

The sub-connector 30 includes one connector main body 31 and one retainer 50. As shown in FIGS. 3 and 5, the connector main body 31 is constituted to include plural pairs of inner conductors 32, one dielectric 33, two sub-boards 34 and 35, one outer conductor 40, and a mating member 45. Each inner conductor 32 is formed from an elongated metal component. The inner conductors 32 paired side by side on the left and right constitute one differential pair circuit. The dielectric 33 is a plate-shaped member whose plate thickness direction is oriented in the front-rear direction. The inner conductors 32 are attached to the dielectric 33 in a state of passing therethrough in the front-rear direction.

Of the two sub-boards 34 and 35, the first sub-board 34 is assembled to the rear surface of the dielectric 33 in a state of overlapping therewith, with the plate thickness direction oriented in the front-rear direction. The inner conductors 32 are connected to the first sub-board 34 is a state of passing therethrough. Of the two sub-boards 34 and 35, the second sub-board 35 is disposed rearward of the first sub-board 34 in a posture with the plate thickness direction thereof oriented in the up-down direction. The first sub-board 34 and the second sub-board 35 are connected via a flexible cable 36. The rear end edge portion of the second sub-board 35 functions as a card edge connection part 37.

As shown in FIGS. 3, 8, and 9, the outer conductor 40 is constituted by assembling a front member 41, a lower case 42, and an upper case 43. The front member 41, the lower case 42, and the upper case 43 are all made of metal. Note that the lower case 42 may also be made of synthetic resin. The front member 41 has four connection ports 44 having a rectangular tubular shape. The four connection ports 44 are disposed so to be aligned in the up-down direction and left-right direction. The front member 41 is attached to the front surface of the dielectric 33 in a state of overlapping therewith. The four pairs of inner conductors 32 attached to the dielectric 33 are disposed such that each pair passes through a different one of the connection ports 44. One pair of inner conductors 32 is disposed in one connection port 44. The mating member 45 made of synthetic resin is attached to the front surface of the front member 41. Four through holes 46 formed in the mating member 45 pass through the mating member 45.

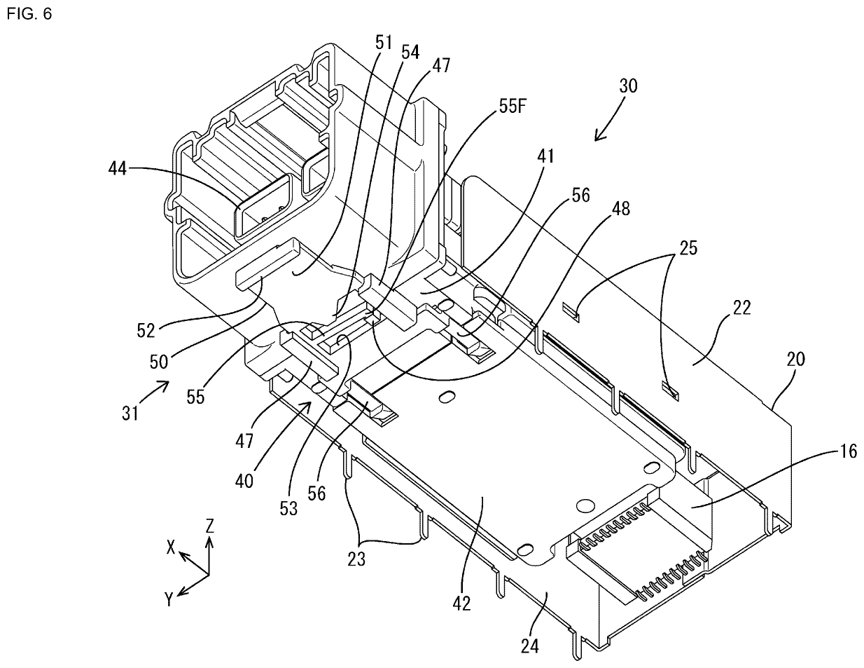

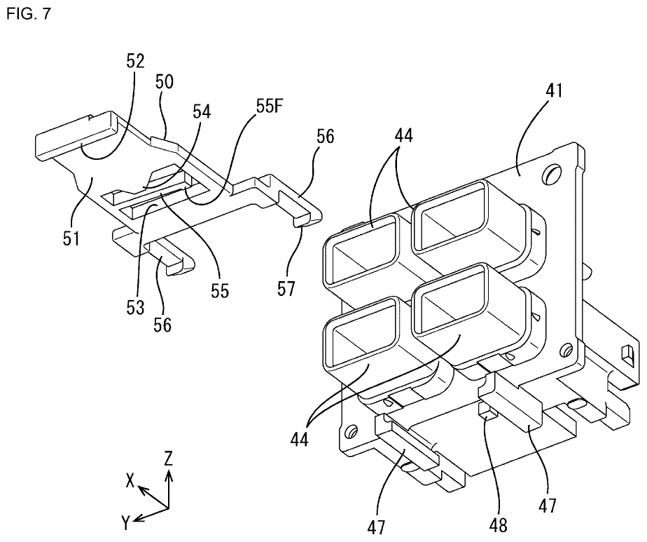

As shown in FIGS. 6 and 7, a pair of bilaterally symmetrical guide parts 47 for attaching the retainer 50 described later to the outer conductor 40 are formed on a lower end portion of the front member 41. In a front view of the front member 41 looking from the front, the pair of guide parts 47 have a shape bent at right angles. A protruding pushing part 48 that protrudes is formed on the lower end surface of the front member 41. The protruding pushing part 48 is disposed at a position leftward of the center of the outer conductor 40 in the left right direction. The protruding pushing part 48 constitutes a locking structure for holding the sub-connector 30 in a state of attachment to the main board 10 and a female connector, in unison with a protruding part 54 and an elastic arm part 55 of the retainer 50 described later. A locked state of the locking structure is released by pushing the retainer 50.

The lower case 42 is assembled to a lower end portion of the front member 41. The lower case 42 extends horizontally rearward from the front member 41, downward of the first sub-board 34 and the second sub-board 35. The second sub-board 35 is placed on the upper surface of the lower case 42. The upper case 43 is assembled so as to cover the second sub-board 35 from above, and is fixed to the second sub-board 35 and the lower case 42 by a screw 49 (see FIG. 3).

The retainer 50 is a single synthetic resin component attached to the connector main body 31. The retainer 50 has a locking function for holding the sub-connector 30 in a state of attachment to the main connector 16. Unlocking the retainer 50 enables the sub-connector 30 to be disengaged from the main connector 16.

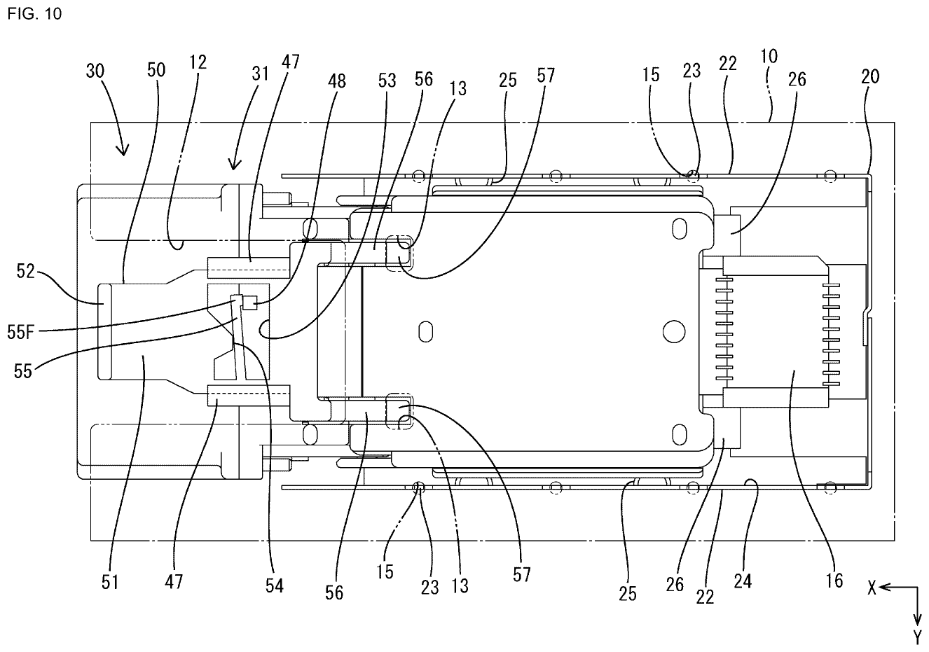

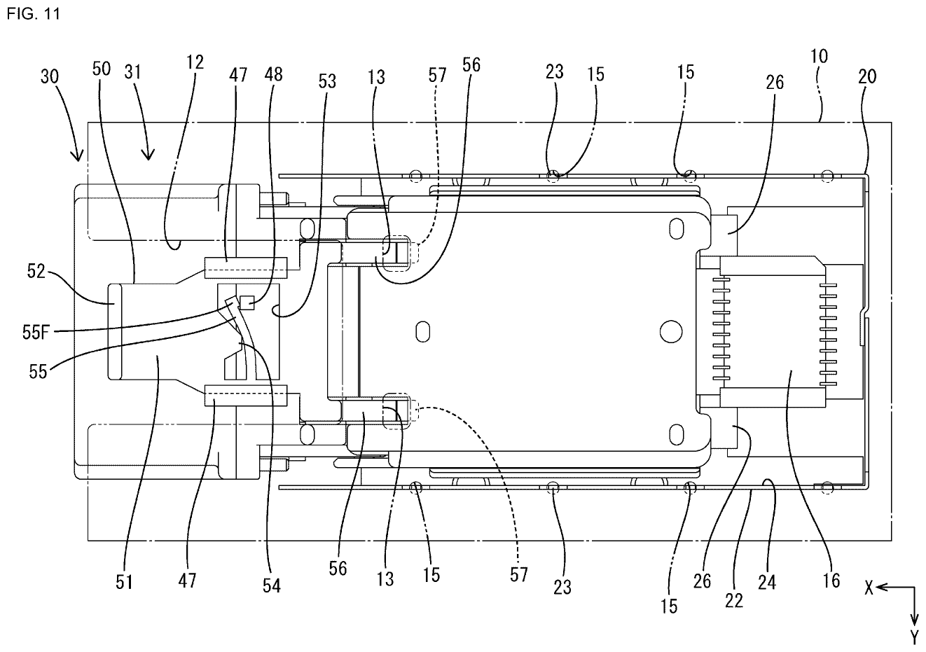

As shown in FIG. 7, the retainer 50 has a plate-shaped main body part 51 whose plate thickness direction is oriented in the up-down direction and a pair of bilaterally symmetrical locking arms 56. On a front end edge portion of the plate-shaped main body part 51 is formed an operation part 52 for use in unlocking that protrudes downward in a rib shape. As shown in FIGS. 10 and 11, a rectangular operating space 53 that is open on both the front and rear surfaces of the plate-shaped main body part 51 is formed in the plate-shaped main body part 51. The protruding part 54 having a trapezoidal shape in plan view is disposed within the operating space 53. The protruding part 54 protrudes rearwardly from a front edge portion of the edge of the opening of the operating space 53.

The elastic arm part 55 is disposed in a region rearward of the protruding part 54 within the operating space 53. The elastic arm part 55 has a shape that extends leftward in a cantilever manner from a right edge portion of the edge of the opening of the operating space 53. The protruding part 54 is disposed in the same position, in the left right direction, as a central portion of the elastic arm part 55 in the extension direction thereof. The elastic arm part 55 can elastically deform in the front-rear direction, with the base end portion of the elastic arm part 55 that is connected to the edge of the opening of the operating space 53 as the point of support. In a state where the elastic arm part 55 is not elastically deformed, clearance in the front-rear direction is secured between the elastic arm part 55 and the protruding part 54.

As shown in FIGS. 7, 10, and 11, the pair of locking arms 56 have a shape that extends rearward in a cantilever manner from a rear end portion of the left and right edges of the plate-shaped main body part 51. Front end portions of the locking arms 56 project outward in a stepped manner in the left right direction with respect to the outer side surfaces of the plate-shaped main body part 51. Latching protrusions 57 that protrude downward are formed on rear end portions of the locking arms 56. As shown in FIGS. 8 and 9, the front surfaces of the latching protrusions 57 are orthogonal to the front-rear direction and function as latching surfaces 58 that latch in the latching holes 13 of the main board 10 from the rear. The rear surfaces of the latching protrusions 57 function as guide surfaces 59 inclined with respect to the front-rear direction. The locking arms 56 can elastically deform in the up-down direction, with the front end portions connected to the plate-shaped main body part 51 as the points of support.

The retainer 50 is attached to the connector main body 31. The plate-shaped main body part 51 is overlapped with the lower end surfaces of the mating member 45 and the front member 41. The left and right side edge portions of the plate-shaped main body part 51 are slidingly mated with the pair of guide parts 47. Guided by the guide parts 47, the retainer 50 is able to move relative to the connector main body 31 between a locked position (see FIGS. 8 and 10) and an unlocked position (see FIGS. 9 and 11) rearward of the locked position. The protruding pushing part 48 of the outer conductor 40 is disposed within the operating space 53. The protruding pushing part 48 is disposed between a free end portion 55F (extension end portion) of the elastic arm part 55 and a rear edge portion of the edge of the opening of the operating space 53.

When attaching the sub-connector 30 to the main board 10, the mating member 45 or the front member 41 of the connector main body 31 is held, and the connector main body 31 is housed within the connection space 24 along the mounting surface 11 from the front of the main board 10. Within the connection space 24, the connector main body 31 is positioned in the up-down direction and the left right direction with respect to the main board 10, due to the holding protrusions 25 coming into sliding contact with the upper surface and left and right outer side surfaces of the connector main body 31. Due to this positioning action, the card edge connection part 37 of the sub-connector 30 is inserted into the board housing space 17 without interfering with the front surface of the main connector 16. Within the board housing space 17, the terminal fittings 18 elastically contact the card edge connection part 37. Attachment of the sub-connector 30 to the main board 10 and connection of the main connector 16 and the sub-connector 30 are thereby completed.

In the process of attaching the sub-connector 30 (i.e., process of connecting the connectors 16 and 30), the guide surfaces 59 of the latching protrusions 57 interfere with the front end edge of the main board 10, directly before connection of the connectors 16 and 30 is completed. When the operation for attaching the connector main body 31 proceeds from this state, the rear end portions of the guide parts 47 push the front end portions of the locking arms 56, whereby the locking arms 56 are elastically displaced upward and the latching protrusions 57 ride up onto the mounting surface 11. Then, when connection of the connectors 16 and 30 is completed, the locking arms 56 elastically return downward, and the latching protrusions 57 latch in the latching holes 13. Due to this latching action, the retainer 50 is held in a state where relative displacement forward with respect to the main board 10 is restricted.

Also, in the process of connecting the connectors 16 and 30, the disengagement pushing parts 26 of the holding member 20 are elastically displaced rearward due to being pushed by the rear end portion of the upper case 43. In the state where connection of the connectors 16 and 30 is completed, the connector main body 31 is pushed forward in the direction of disengagement from the main connector 16 by the elastic restoring force of the disengagement pushing parts 26. Due to this pushing force, the connector main body 31 is displaced forward relative to the retainer 50, and the protruding pushing part 48 pushes the free end portion 55F (left end portion) of the elastic arm part 55 forward, and thus the elastic arm part 55 is elastically displaced forward and a central portion of the elastic arm part 55 in the left right direction abuts against the protruding part 54.

The attachment position of the sub-connector 30 to the main board 10 and the main connector 16 is determined where the elastic restoring force of the elastic arm part 55 that has been elastically displaced forward, the forward elastic restoring force of the disengagement pushing parts 26 elastically deformed rearward, the frictional resistance between the holding protrusions 25 and the connector main body 31, and the frictional resistance between the card edge connection part 37 and the terminal fittings 18 are in equilibrium (see FIG. 10). In a state where the sub-connector 30 is attached to the main board 10 and the main connector 16, the plate-shaped main body part 51 of the retainer 50 is housed within the notch part 12 of the main board 10 and is disposed in the locked position. The operation part 52 of the retainer 50 is exposed at the front end of the main board 10. The front end of the operation part 52 is disposed in the same position as the front end of the main board 10 in the front-rear direction.

When removing the sub-connector 30 that is attached to the main board 10 and the main connector 16, the operation part 52 of the retainer 50 is pushed rearward from the front of the main board 10 and moved to the unlocked position side. In the process in which the retainer 50 is pushed, the locking arms 56, as shown in FIG. 9, are elastically displaced upward due to the inclination of the guide surfaces 59, and the latching protrusions 57 are disengaged upward from the latching holes 13 and ride up onto the upper surface of the front end edge portion of the lower case 42.

While the retainer 50 is moving to the unlocked position, the free end portion 55F of the elastic arm part 55 is in contact with the protruding pushing part 48, within the operating space 53 of the retainer 50, and thus the elastic arm part 55 moves forward relative to the protruding part 54. As a result, the protruding part 54 pushes on the central portion of the elastic arm part 55 in the left-right direction from the front, and thus the elastic arm part 55 is elastically deformed so as to bulge rearward, as shown in FIG. 11. When the amount of elastic deformation of the elastic arm part 55 reaches a certain degree, the retainer 50 cannot be pushed further in the unlocking direction. The position of the retainer 50 at this time is the unlocked position.

When the retainer 50 reaches the unlocked position, the latching protrusions 57 detach from the latching holes 13, and thus it becomes possible for the retainer 50 and the connector main body 31 to move forward relative to the main board 10. While the retainer 50 is moving from the locked position to the unlocked position, the elastic force of the disengagement pushing parts 26 of the holding member 20 is constantly applied to the connector main body 31. When the finger is moved away from the operation part 52 after pushing the retainer 50 to the unlocked position, the connector main body 31 is pushed forward by the elastic force of the disengagement pushing parts 26. Due to the pushing force acting on the elastic arm part 55 and the protruding part 54 from the protruding pushing part 48 at this time, the retainer 50 moves forward relative to the connector main body 31 and returns to the locked position. Thereafter, the mating member 45 or the front member 41 of the sub-connector 30 need only be held and the sub-connector 30 pulled out forward.

The board connector device of Embodiment 1 includes the main board 10, the main connector 16 mounted on the mounting surface 11 of the main board 10, and the sub-connector 30. The sub-connector 30 includes the sub-boards 34 and 35, and is attached to the main board 10 in a state where the second sub-board 35 is connected to the main connector 16. The sub-connector 30 is provided with the retainer 50 that holds the sub-connector 30 in a state of attachment to the main board 10 by latching onto the main board 10. Detaching the retainer 50 from the main board 10 enables the sub-connector 30 to be disengaged from the main board 10. According to this configuration, the second sub-board 35 and the main connector 16 are held in a connected state by the retainer 50, even if frictional resistance between the second sub-board 35 and the main connector 16 is not enhanced, and thus an improvement in usability when disengaging the second sub-board 35 from the main connector 16 can be achieved.

The retainer 50 has the operation part 52. The operation part 52 is exposed on the outer periphery of the main board 10, in a state where the latching protrusions 57 of the locking arms 56 are latched in the latching holes 13 of the main board 10. The retainer 50 detaches from the main board 10, by a pushing force parallel to the main board 10 being applied to the operation part 52. According to this configuration, operability at the time of removing the sub-connector 30 from the main board 10 is good.

The retainer 50 has the plate-shaped main body part 51 (projecting part) disposed on the surface (lower surface) of the sub-connector 30 that opposes the mounting surface 11. In a state where the sub-connector 30 is attached to the main board 10, the plate-shaped main body part 51 is housed within the notch part 12 formed on the main board 10. A reduction in profile in the plate thickness direction of the main board 10 can thereby be achieved, compared to the case where the plate-shaped main body part 51 is placed on the mounting surface 11 of the main board 10. The notch part 12 is disposed only within the range of the region of the mounting surface 11 that is covered by the sub-connector 30. According to this configuration, the mounting surface 11 of the main board 10 can be effectively utilized for disposition of circuits, elements, and the like.

The main board 10 is provided with the disengagement pushing parts 26 that push the sub-connector 30 in the direction of disengagement from the main board 10. The disengagement pushing parts 26 are formed on the holding member 20 fixed to the main board 10. Once the latching protrusions 57 of the retainer 50 are detached from the latching holes 13 in the main board 10, the sub-connector 30 is pushed in the direction of disengagement from the main board 10 by the disengagement pushing parts 26, and thus usability at the time of disengagement is excellent. The disengagement pushing parts 26 are made of an elastic material. The disengagement pushing parts 26 elastically push the sub-connector 30 in the disengagement direction (forward), in a state where the retainer 50 is latched onto the main board 10. According to this configuration, usability when disengaging the sub-connector 30 from the main board 10 is further improved.

The main board 10 is fixedly provided with the holding member 20 having the holding protrusions 25. The holding member 20 holds the sub-connector 30 in a state of attachment to the main board 10, by the frictional force between the holding protrusions 25 and the sub-connector 30. The elastic force that is applied to the sub-connector 30 by the disengagement pushing parts 26 is set to a strength that exceeds the holding force applied by the holding member 20. According to this configuration, the sub-connector 30 can be held in a state of attachment to the main board 10 without any play. Also, the sub-connector 30 can be disengaged from the main board 10 and the holding member 20 by the disengagement pushing parts 26.

The holding member 20 is made of a conductive material and forms a box shape that encloses the sub-connector 30. The upper case 43 constituting the outer conductor 40 of the sub-connector 30 contacts the holding member 20. According to this configuration, a high shielding effect can be obtained by the outer conductor 40 and the holding member 20.

### Other Embodiments

The present disclosure is not limited to the embodiments illustrated by the above description and drawings, and is indicated by the claims. The present disclosure encompasses all modifications within the claims, and also encompasses embodiments such as the following.

A configuration may be adopted in which the retainer is disengaged from the main board by being pulled from a state of latching onto the main board.

A configuration may be adopted in which the projecting part of the retainer is placed on the mounting surface of the main board.

A configuration may be adopted in which at least part of the notch part is disposed in a region of the mounting surface that is not covered by the sub-connector.

A configuration may be adopted in which the main board is not provided with the disengagement pushing parts.

A configuration may be adopted in which the sub-connector is disengaged from the main board, by manually operating the disengagement pushing parts.

The holding member may also be made of a non conductive material.

The holding member may also have a shape other than a box shape.

The board connector device of the present disclosure is not limited to an Ethernet communication circuit, and can also be applied to communication circuits other than an Ethernet communication circuit and to a power circuit.

The board connector device of the present disclosure can also be applied to the case where the sub-connector does not have connection ports and is connected to the end portion of a conductive path such as a wire harness or a flexible cable.

1. A board connector device comprising:
a main board;
a main connector mounted on a mounting surface of the main board;
a sub-connector including a sub-board and attached to the main board in a state where the sub-board is connected to the main connector; and
a retainer provided in the sub-connector, holding the sub-connector in a state of attachment to the main board by latching onto the main board, and configured to disengage the sub-connector from the main board by detaching from the main board,
wherein the main board has a latching hole formed therein, and
when connection of the main connector and the sub-connector is completed, the retainer latches in the latching hole.

2. The board connector device according to claim 1,
wherein the retainer includes an operation part exposed on an outer periphery of the main board, in a state where the retainer is latched onto the main board, and
the retainer is detached from the main board, by a pushing force parallel to the main board being applied to the operation part.

3. The board connector device according to claim 1,
wherein the retainer has a projecting part disposed on a surface of the sub-connector opposing the mounting surface, and
the projecting part is housed in a notch part formed in the main board, in a state where the sub-connector is attached to the main board.

4. The board connector device according to claim 3, wherein the notch part is disposed only within a range of a region of the mounting surface covered by the sub-connector.

5. The board connector device according to claim 1, wherein the main board is provided with a disengagement pushing part that pushes the sub-connector in a direction of disengagement from the main board.

6. The board connector device according to claim 5, wherein the disengagement pushing part is made of an elastic material, and elastically pushes the sub-connector in the disengagement direction, in a state where the retainer is latched onto the main board.

7. The board connector device according to claim 6,
wherein the main board is provided with a holding member that holds the sub-connector in a state of attachment to the main board by a frictional force between the holding member and the sub-connector, and
an elastic force applied to the sub-connector by the disengagement pushing part is set to a strength exceeding a holding force applied by the holding member.

8. The board connector device according to claim 7,
wherein the holding member is made of a conductive material and has a box shape enclosing the sub-connector, and
an outer conductor constituting the sub-connector contacts the holding member.

9. The board connector device according to claim 2,
wherein the retainer has a projecting part disposed on a surface of the sub-connector opposing the mounting surface, and
the projecting part is housed in a notch part formed in the main board, in a state where the sub-connector is attached to the main board.

10. The board connector device according to claim 2, wherein the main board is provided with a disengagement pushing part that pushes the sub-connector in a direction of disengagement from the main board.

11. The board connector device according to claim 3, wherein the main board is provided with a disengagement pushing part that pushes the sub-connector in a direction of disengagement from the main board.

12. The board connector device according to claim 4, wherein the main board is provided with a disengagement pushing part that pushes the sub-connector in a direction of disengagement from the main board.
